(19) United States
(12) Patent Application Publication
(10) Pub. No.: US 2024/0198611 A1
(43) Pub. Date: Jun. 20, 2024

(54) AUTOMATON FOR APPLYING A PATCH TO A HEATED SURFACE

(71) Applicant: SAFRAN NACELLES, Gonfreville-L'orcher (FR)

(72) Inventors: Benjamin Provost, Moissy Cramayel (FR); Clément Rolland, Moissy Cramayel (FR); Maxime Lebegue, Moissy Cramayel (FR); Renaud Venture, Moissy Cramayel (FR)

(73) Assignee: SAFRAN NACELLES, Gonfreville-L'orcher (FR)

(21) Appl. No.: 18/287,130

(22) PCT Filed: May 6, 2022
(86) PCT No.: PCT/FR2022/050872

§ 371 Date: Oct. 16, 2023

(30) Foreign Application Priority Data
May 10, 2021 (FR) FR2104939

(51) Int. Cl. B29C 73/12; B25J 15/00; B25J 15/06

(52) U.S. Cl. CPC B29C 73/12; B25J 15/0085; B25J 15/0616

(57) ABSTRACT

This automaton for applying a patch to a draping surface (15) comprises a gripper (24) capable of grasping the patch and depositing it on the draping surface (15), and a heating system (25) for directly heating the draping surface (15).

### TECHNICAL FIELD

The present invention relates to the manufacture of composite parts and, in particular, the deposition of patches of pre-impregnated fibrous or non-fibrous material over a part during manufacture.

More particularly, the present invention relates to grippers intended to grasp and drape patches of material over a part being manufactured, a patch being in the form of a thin material whose tackiness should be activated by heat so that the patch properly adheres to the target part.

### PRIOR ART

In general, laying a patch over large surfaces is carried out using a gripper to grasp and then deposit a patch at the desired location over the surface of the target part. For example, current solutions use pneumatic, electrostatic or mechanical grippers.

In the case of a pneumatic gripper, the gripper grasps the patch by suction by creating a depression which enable the patch to be pressed against the gripper until the gripper is positioned opposite the part over which the patch should be positioned. The patch is then pressed and slightly compacted against the part, the depression is stopped and the gripper withdraws, leaving the patch over the target surface to be draped. For example, the patch is an adhesive.

In order to increase the tackiness and stickiness of a patch, to facilitate its adherence to the target part, it is useful to expose it to a heat source.

An automaton 1 for applying a patch according to the prior art is shown in FIGS. 1a and 1b. The automaton 1 comprises a carrier 2 carrying a gripper 3 able to grip and lay patches over a target surface 4. For example, the carrier 2 is a robotic arm or a numerically-controlled machine.

A remote heating system 5 is present in the surrounding of the target surface 4 so that the carrier 2 of the automaton 1 grasps a patch on a supply device (not shown) by means of the gripper 3, then approaches the patch proximate to the heating system 5 as illustrated in FIG. 1a. The patch thus heated has a tackiness allowing bonding it to the target surface 4 when positioning the patch by the gripper 3 over the target surface 4 (FIG. 1b). For example, the supply device is a table, a conveyor belt or a drawer system.

A computer 6 monitors the gripping, heating and laying operations.

However, such a configuration requires the carrier of the automaton to make the gripper perform a travel between the heating system and the target surface, a travel during which the patch cools down and loses its sufficiently tacky nature.

One solution consists in heating the patch up to a higher temperature to compensate for cooling. Nonetheless, this rise in temperature could degrade the material of the patch.

In addition, heating the patch when it is in contact with the gripper activates the tackiness of the patch also on its surface in contact with the gripper, which is detrimental to the proper detachment of the patch and the gripper when laying it over the target surface.

The draping time of the target surface is also increased by the heating and the additional travel of the carrier between the heating system and the part to be draped.

### DISCLOSURE OF THE INVENTION

Hence, the present invention aims to overcome the aforementioned drawbacks and to improve the efficiency of the systems for gripping and depositing patches, while limiting sticking of the patch to the gripper, and while improving the adhesion of the patch to the target surface to be draped.

An object of the present invention is an automaton for applying a patch over a surface to be draped, the automaton comprising a gripper able to grasp the patch and deposit it over the surface to be draped, and a system for heating the surface to be draped able to directly heat said surface to be draped.

Thus, the direct heating of the target surface to be draped allows reducing the travel time of the gripper, and consequently, avoiding overheating the patches, in order to avoid degrading the patch, and promoting bonding of the patch to the surface to be draped while avoiding sticking of the patch to the gripper.

Advantageously, the gripper comprises a selectively activatable gripping system and a deformable material positioned against a gripping surface of the gripping system.

Advantageously, the gripping system is pneumatic or mechanical or electrostatic.

In one embodiment, the automaton comprises a carrier and a head carried by the carrier, the head comprising a gripper and a system for heating the surface to be draped. For example, the carrier is a robotic arm or a numerically-controlled machine.

In another embodiment, the automaton comprises a first carrier comprising a first head and a second carrier carrying a second head, one amongst the first and second heads comprising the gripper and the other one comprising the heating system.

Advantageously, the heating system is connected to the head of the automaton by a mechanism or a linkage so that the heating system is retractable.

According to one embodiment, the mechanism is a pivot connection.

Advantageously, the heating system is a lamp, or a hot air blower, or a resistor.

Another object of the invention is a method for positioning a patch over a surface to be draped, comprising the following steps:
Gripping a patch by the gripper of the automaton as described before;
Heating the surface to be draped by means of the heating system of the automaton; and
Laying the patch over the surface to be draped by means of the gripper.

### BRIEF DESCRIPTION OF THE DRAWINGS

Other aims, features and advantages of the invention will appear upon reading the following description, given merely as a non-limiting example, and made with reference to the appended drawings wherein:

FIG. 1a

and

FIG. 1b which has already been mentioned, schematically illustrate an automaton for applying a patch according to the prior art;

FIG. 2a

and

FIG. 2b are schematic views of an automaton for applying a patch according to a first embodiment of the invention;

FIG. 3 schematically illustrates a gripper of an automaton according to a first embodiment of the invention;

FIG. 4a

and

FIG. 4b are schematic views of an automaton for applying a patch according to a second embodiment of the invention;

FIG. 5 schematically illustrates a head of an automaton according to a first variant of a second embodiment of the invention;

FIG. 6 schematically illustrates a head of an automaton according to a second variant of a second embodiment of the invention; and

FIG. 7 illustrates the steps of a method for gripping and positioning a patch using an automaton according to the invention.

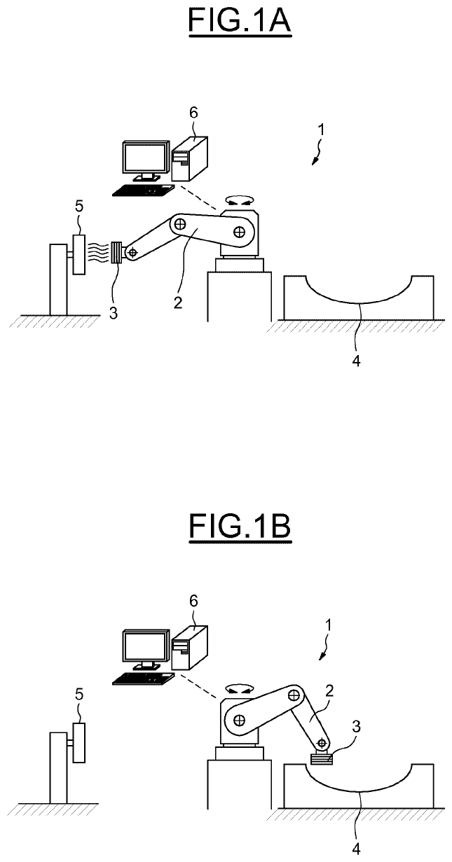

### DETAILED DISCLOSURE OF AT LEAST ONE EMBODIMENT

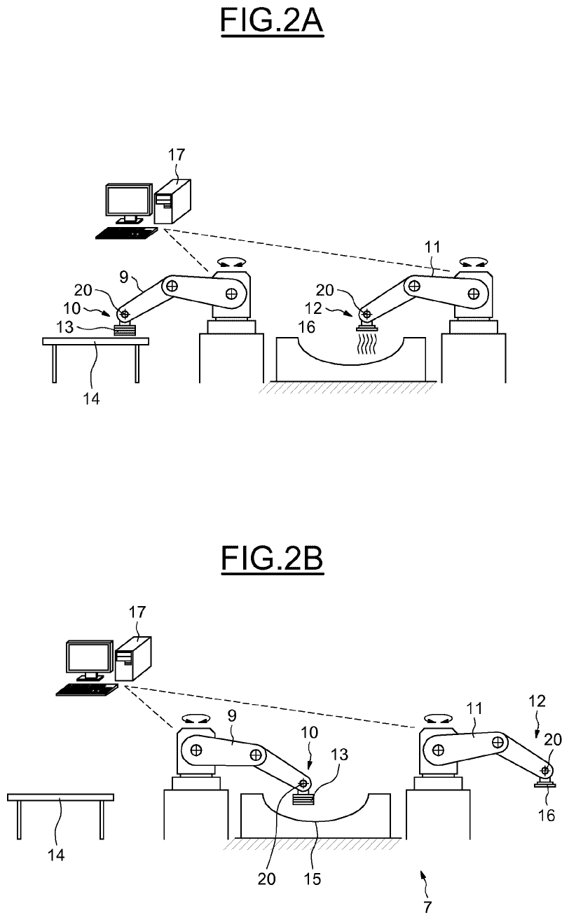

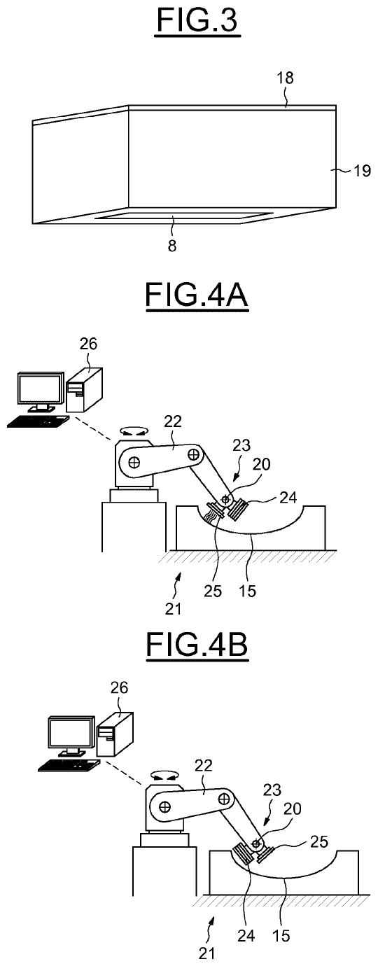

A first embodiment of an automaton 7 for applying a patch 8, visible in FIG. 3, is shown in FIGS. 2a and 2b.

In this first embodiment, the automaton 7 comprises a first robotic carrier 9 comprising a first head 10, as well as a second robotic carrier 11 carrying a second head 12.

The first head 10 comprises a gripper 13 able to grasp the patch 8 on a supply device 14 and to deposit said patch 8 over a surface to be draped 15. For example, the supply device is a work table, a conveyor belt or a drawer system.

The second head 12 comprises a system 16 for heating the surface to be draped 15 able to directly heat said surface 15. By direct heating, it should be understood heating the part by the heating means of the heating system, without the part being heated through an intermediate part.

In this first embodiment, a computer 17 commands the automaton 7 and synchronises the two carriers 9 and 11 so that the second carrier 11 carrying the second head 12 starts heating the surface to be draped 15 by means of the heating system 16 while the first carrier 9 starts grasping the patch 8 on the supply device 14, by means of the gripper 13, as illustrated in FIG. 2a.

As illustrated in FIG. 2b, after the gripper 13 has grasped the patch, the first carrier 9 moves towards the surface to be draped 15 and starts depositing the patch 8 over the surface to be draped 15 as soon as the second carrier 11 withdraws after having heated the surface to be draped 15.

In this embodiment, the gripper 13, as shown in FIG. 3, comprises a selectively activable gripping system 18, for example a pneumatic gripping system capable of creating vacuum suction, and a deformable material 19 positioned at the gripping surface of the gripping system. By selectively activatable, it should be understood the ability of the gripping system to be able to grasp a patch if the gripping system 18 receives this order by command from the computer 17, or not to grasp it if the command from the computer so requires.

The deformable material 19, for example an elastically-deformable foam, enables the gripper to adapt to any shape of the surface to be draped 15.

Alternatively, electrostatic or mechanical gripping systems may also be used.

For example, the heating system 16 is a lamp, or a hot air blower or a resistor.

In this first embodiment, the gripper 13 and the heating system 16 are respectively connected to the first and second heads 10 and 12 by linkages 20 enabling the gripper 13 and the heating system 16 to be retractable, and/or orientable. In particular, the linkages 20 consist for example of pivot connections or multi-axis systems.

In a second embodiment shown in FIGS. 4a and 4b, the automaton 21 comprises a robotic carrier 22 and a head 23 carried by said carrier 22. The head 23 comprises both a gripper 24 able to grasp the patch 8 and deposit it over the surface to be draped 15, and a system 25 for heating the surface to be draped 15 able to directly heat the surface to be draped 15. This embodiment is for example preferable if savings of means and spaces are necessary.

As illustrated in FIG. 4a, in this second embodiment, a computer 26 commands the automaton 21 and, after the gripper 24 has grasped the patch 8, directs the head 23 towards the surface to be draped 15, and orients in a first step the head 23 so that the heating system 25 is arranged opposite the surface to be draped 15 and heats the latter.

In a second step, with reference to FIG. 4b, after heating the surface to be draped 15, the head 23 pivots in order to present the gripper 24 with the patch 8 opposite the surface to be draped 15.

Like in the first embodiment, laying the patch is performed only a few moments after heating of the surface to be draped. The surface being hot, it thermally activates the patch to reinforce its tacky nature on the side of the surface to be draped. This avoids overheating of the patch and facilitates bonding between the patch and the surface to be draped, without activating the tackiness of the patch on the gripper side.

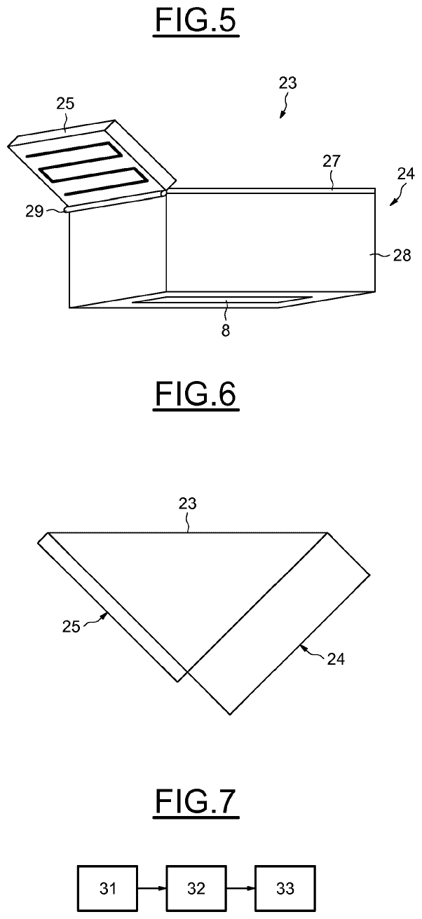

In a variant of the second embodiment shown in FIG. 5, the head 23 includes the gripper 24 and the heating system 25.

The gripper 24 comprises a selectively activable gripping system 27, for example a pneumatic gripping system capable of creating vacuum suction, and an elastically-deformable material 28 positioned against a gripping surface of the gripping system 27.

The deformable material 28, for example a foam, enables the gripper 24 to adapt to any shape of the surface to be draped 15.

Alternatively, electrostatic or mechanical gripping systems may also be used.

For example, the heating system 25 is a lamp, or a hot air blower or a resistor. It is activated and controlled by the computer 26 and the automaton 21, for example with regards to power and heating time.

In a variant of this second embodiment illustrated in FIG. 5, the heating system 25 is connected to the head 23 of the automaton by a mechanism 29, for example a pivot connection, enabling the heating system 25 to be retractable and thus to have a reduced size, for example when laying the patch 8. In particular, the mechanism 29 directly connects the heating system 25 and the gripper 24.

In a second variant of the second embodiment, illustrated in FIG. 6, the heating system 25 and the gripper 24 are connected directly to the head 23 of the automaton 21 so that their faces intended to interact with the surface to be draped 15 are opposite one another and always form the same angle, for example about 90°. This variant requires more movements from the carrier 22.

In these two variants, the head 23 is also provided with a linkage 20 enabling the gripper 24 and the heating system 25 to be retractable, and/or orientable. In particular, the linkage 20 is for example a pivot connection or a multi-axis system.

In each embodiment, the method for positioning a patch 8 over a surface to be draped 15, the steps of which are shown in FIG. 7, comprises a first step 31 of gripping a patch 8 by the gripper 13 or 24 of the automaton 7 or 21.

Afterwards, a second step 32 of heating the surface to be draped 15 by means of the heating system 16 or 25 is performed.

Finally, a last step 33 of laying the patch 8 over the surface to be draped 15 is performed by means of the gripper.

1. An automaton for applying a patch to a surface to be draped, the automaton comprising a gripper adapted to grasp the patch and to deposit it over the surface to be draped, and a system for heating the surface to be draped adapted to directly heat said surface, the gripper comprising a selectively activatable gripping system and a deformable material positioned against a gripping surface of the gripping system.

2. The automaton according to claim 1, wherein the gripping system is pneumatic or mechanical or electrostatic.

3. The automaton according to claim 1, further comprising a carrier and a head carried by the carrier, the head comprising a gripper and a system for heating the surface to be draped.

4. The automaton according to claim 1, further comprising a first carrier comprising a first head and a second carrier carrying a second head, one amongst the first and second heads comprising the gripper and the other one comprising the heating system.

5. The automaton according to claim 1, wherein the heating system is connected to the head of the automaton by a mechanism or a linkage so that the heating system is retractable.

6. The automaton according to claim 5, wherein the mechanism is a pivot connection.

7. The automaton according to claim 1, wherein the heating system is a lamp, or a hot air blower, or a resistor.

8. A method for positioning a patch over a surface to be draped, the method comprising:
Gripping a patch by the gripper of the automaton according to claim 1;
Heating the surface to be draped by means of the heating system of the automaton; and
Laying the patch over the surface to be draped by means of the gripper.
